(19) United States
(12) Patent Application Publication
(10) Pub. No.: US 2008/0115731 A1
(43) Pub. Date: May 22, 2008

(54) Hay bale feeding and covering apparatus

(76) Inventor: A. Albert Walker, Sussex, NJ (US)

Correspondence Address: TIMOTHY M. BARLOW, CMR 480 Box 0007, APO, AE, 09128, omitted

(21) Appl. No.: 11/602,151

(22) Filed: Nov. 20, 2006

(51) Int. Cl. A01K 5/00

(52) U.S. Cl. 119/58; 119/63

(57) ABSTRACT

A portable bale feeder comprises a semicircular barrier having a pair of terminal ends and a center frame section, a pair of wheels attached adjacent to the terminal ends, and an anchoring stake. The semicircular barrier further includes a plurality of semicircular horizontal bars joined by a plurality of cross links. A plurality of slant bars is attached between two or more or the horizontal bars to create a plurality of feeder openings. In one embodiment, a flexible cover deployment and retrieval system is attached to the feeder. In another embodiment, the flexible cover deployment and retrieval system is attached to an inverted U frame member that is attached to the terminal ends of the semicircular barrier. The flexible cover deployment and retrieval system includes a boom for holding a spool of plastic sheeting, or a reel mechanism pivotally attached to the inverted U frame member.

### BACKGROUND OF THE INVENTION

1. Field of the invention

The present invention relates to an agricultural and livestock care implement, and more particularly to a hand drawn hay bale feeder mounted on wheels for improved portability, and having an attachment for covering a row of abutting hay bales with a plastic cover and for retrieving the plastic cover.

2. Description of the related art

The related art of interest describes various hay bale feeding and wrapping apparatus, but none discloses the present invention. There is a need for a multi-purpose wheeled hay bale feeder apparatus useful for covering a line of hay bales, hay bale feeding, and retrieving the cover by utilizing a one-man-power drawn apparatus.

The relevant art will be discussed in the order of perceived relevance to the present invention.

U.S. Pat. No. 5,477,811, issued on Dec. 26, 1995 to Haskell Nobles et al., describes a hay bale feeding trailer having two rear wheels, a bale lift, a support tine, a rear hinged gate, and a fixed top cover.

U.S. Pat. No. 3,972,308, issued on Aug. 3, 1976 to Daniel F. Ray, describes a vehicle-transportable feeder frame apparatus for enclosing and moving pre-formed haystacks to the animals for feeding from the trailer.

U.S. Pat. No. 5,385,002, issued on Jan. 31, 1995 to David J. Cundall, describes a sheathing apparatus for completely covering a line of hay bales by towing along the side of a tractor. A circular frame having the stretched plastic sheath is towed along the hay bales to completely cover the bales.

U.S. Pat. No., 5,067,442, issued on Nov. 26, 1991 to Harold Schilling, describes a collapsible forage feeding cart.

U.S. Pat. No. 5,709,064, issued on Jan. 20, 1998 to Denny M. Swartz, describes a method and device for covering crop bales positioned end to end on a raised earthen mound. An elongated needle is used to insert strands of tie material under the bales, and then the tie material is pulled up over the top surface of a cover sheet on top of the bales. The strands of the tie material are then tied in position to encircle the bales and the cover sheet to hold it in position on at least the top half of the bales.

U.S. Pat. No. 5,561,971, issued on Oct. 8, 1996 to Roy E. Sampson, describes a portable round bale wrapping apparatus which wraps large cylindrical straw bales with a plastic film for storage in the fields.

U.S. Pat. No. 5,740,662, issued on Apr. 21, 1998 to Erling Ryneberg et al., describes a bale wrapper apparatus comprising an arched frame on four wheels for lifting and rotating a hay bale and wrapping it with a plastic cover from a holder on a boom.

U.S. Pat. No. 4,890,443, issued on Jan. 2, 1990 to Martin R. Diehm, describes a device for wrapping plastic sheet material around a round hay bale, attached to an existing hay baler. The attachment includes a front mounted table having a sledable carriage movable across the width of the table, a cartridge of plastic sheet material, and a plastic sheet guide pivotally mounted at an outer end of a pre-existing twine arm.

U.S. Pat. No. 5,596,864, issued on Jan. 28, 1997 to Holdsworth Reeves, describes a cylindrical bale-wrapping machine hydraulically operated by its own engine comprises a four wheel trailer having a rotatable bale-wrapping ring and a ram feed device in front on a cantilevered feeding ramp. Plastic sheeting is wrapped around an individual bale.

U.S. Pat. No. 5,661,956, issued on Sep. 20, 1997 to Jean-Roch Tardif, describes a bale wrapping apparatus including a sled with a shallow angle to the horizontal with a trough for receiving individual bales fed through a ring and a continuous plastic sheath covering.

U.K. Patent No. 2 159 489 A, published on Dec. 4, 1985, describes an apparatus for wrapping one round hay bale with a plastic cover by rotating the bale around both its horizontal and vertical axes simultaneously by a rotatable turntable device which can also pick-up and off-load the bale.

German Patent Application No. 36 42 513 A1, published on Jun. 23, 1988, describes a bale wrapper machine for tractors having a fork lift to raise the hay bale from the ground during wrapping to prevent damage to the bale.

U.S. Pat. No. 4,981,407, issued on Jan. 1, 1991 to Jerry Johnson, describes a large bale transporter and feeder trailer having a rear lift.

U.S. Pat. No. 5,076,752, issued on Dec. 31, 1991 to DuWayne Rader, describes a multi-purpose wheeled hay bale carrying trailer having three configurations to perform different tasks. A first configuration permits hauling three hay bales. A second configuration permits unloading by rotating its side frame members about their longitudinal outer edges. A third configuration permits feeding by rotating its side members about their longitudinal inner edges.

None of the above inventions and patents, taken either singularly or in combination is seen to describe the instant invention as claimed. Thus a hay bale feeder apparatus adaptable for covering a line of hay bales, and retrieving the cover which solves the aforementioned problems is desired.

### SUMMARY OF THE INVENTION

The portable bale feeder includes a semicircular barrier having a pair of terminal ends and a center frame section. A pair of wheels is attached to the barrier adjacent to the terminal ends. An anchoring stake is provided in the center frame section and prevents the barrier from being displaced by feeding animals. The barrier includes a plurality of semicircular horizontal bars and a plurality of cross links attached to and perpendicular to the horizontal bars. A plurality of slant bars are attached between two or more of the semicircular horizontal bars to create a plurality of feeder openings. In one embodiment, the portable barrier feeder includes a flexible cover deployment and retrieval system. The continuous sheets of flexible plastic can cover long rows of bales. In another embodiment, the barrier includes an inverted-U frame member that is attached to the terminal ends of the semicircular barrier. This member provides some extra rigidity and a mounting position for additional features.

The hay bale feeder defines a generally semicircular cage with slant bars that define a plurality of livestock feeder openings. The arched shape of the barrier envelopes a bale on three sides and the barrier is easily repositioned to make more feed available.

The feeder is easily towed with a tractor or pushed like a wheelbarrow to a feeding site, and then can be pushed around the end bales in a row of hay bales aligned end to end, and stabilized in a fixed position by a ground stake. The livestock access the feed through the feeder openings.

The hay bale feeder can be fitted with a removable boom attachment, which extends outboard from the feeder. A roll of plastic may be placed on the boom, secured to the end bale, and then unrolled over the row of hay bales, by moving the feeder along and beside the hay bales. The hay bale feeder may also be equipped with an attachment for recovering the plastic cover for reuse and to reduce ground litter. The retrieval apparatus is mounted to an inverted-U frame member that is in turn mounted to the terminal ends of the feeder. An empty spool or core is mounted between the hubs. An end of the plastic cover is wound onto the core, and the feeder is advanced over the row of abutted hay bales. An internal spring winds the plastic cover on to the core.

Accordingly, it is a principal object of the invention to provide a semicircular hay bale feeder that surrounds a hay bale on three sides, and that has a pair of wheels so that the feeder may be transported to a row of hay bales either manually, by pushing the feeder in wheelbarrow fashion, or by towing with a tractor.

It is another object of the invention to provide a hay bale feeder with a boom extension for laying a plastic cover over a row of hay bales aligned end to end in order to preserve the feed.

It is a further object of the invention to provide a hay bale feeder with an attachment for recovering a plastic cover laid over a row of hay bales, so that the plastic cover may be reused.

Still, another object of the invention is to provide a hay bale feeder with attachments for covering hay bales with plastic, and recovering the plastic for reuse, which is faster and easier to use than conventional covering devices by covering an entire row of hay bales with a single sheet of plastic, rather than covering each bale individually.

It is also an object of the invention to eliminate moving heavy bales (600 to 1600 lbs.) during the winter months, or to space them 16 feet apart or more, as is required when moving a round bale feeder, from one bale to the next. This permits about three times the volume of hay to be stored in a feed lot, and greatly reduces tractor operation expenses and injury.

It is an object of the invention to provide improved elements, and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of a hay bale feeder, according to the present invention;

FIG. 2 is a side view of a fully charged hay bale feeder, according to the present invention;

FIG. 3 is a fragmented view of the center frame section of the hay bale feeder with a tractor draw bar, according to the present invention;

FIG. 4 is a side view of a flexible cover deployment system accessory for the hay bale feeder, according to the present invention;

FIG. 5 is an environmental view of the hay bale feeder with the flexible cover deployment system extended, according to the present invention;

FIG. 6 is a side view of the hay bale feeder with the flexible cover deployment system stowed, according to the present invention;

FIG. 7 is an environmental view of the hay bale feeder with the flexible cover retrieval system mounted, according to the present invention;

FIGS. 8A and 8B show elevated environmental views of feeder assemblies in use, according to the present invention;

FIG. 9 shows an elevational environmental view of the feeder system in use, according to the present invention;

FIG. 10 is a flowchart of the steps in a feeder system, according to the present invention; and

FIG. 11 is an elevational environmental view of the flexible cover deployment system in use, according to the present invention.

### DETAILED DESCRIPTION OF THE PREFERRED EMBODIMENT

The present invention is directed to a hay bale feeder which may be equipped with attachments for laying a plastic cover over a row of hay bales.

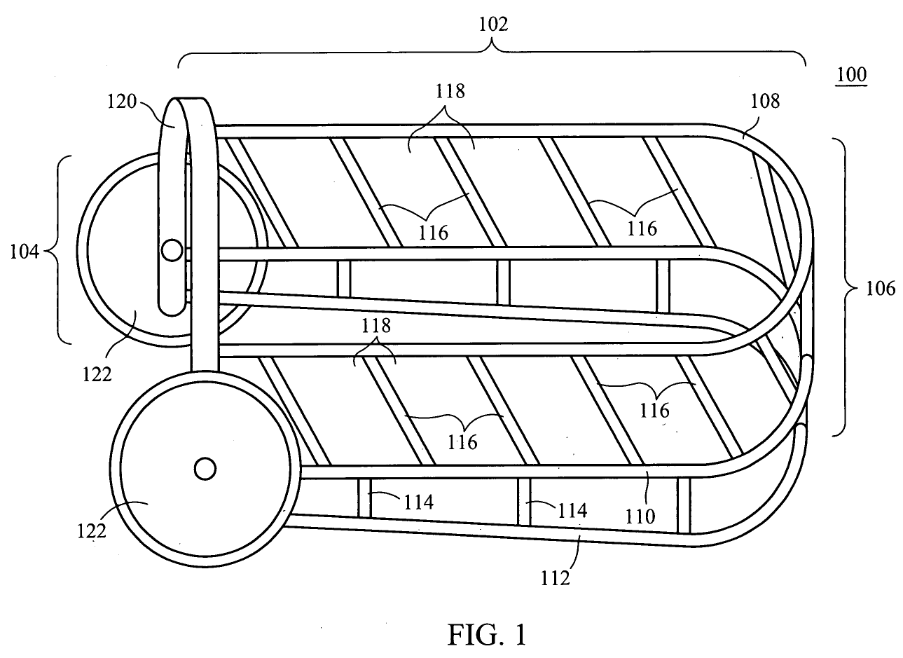

FIG. 1 shows a perspective view of a hale bale feeder 100 that includes a semicircular barrier component 102 having a pair of terminal ends 104 and a center frame section 106. The semicircular barrier component 102 may also be a horizontal U-shape, as shown, and includes several components. The barrier 102 includes a top rail 108, center rail 110 and bottom rail 112. These three rails 108, 110, 112 are generally horizontal. Top rail 108 and center rail 110 are generally parallel, but bottom rail 112 slants downward away from the terminal ends 104: A plurality of cross links 114 are shown fixed between the center rail 110 and the bottom rail 112 and act to impart strength and rigidity to the barrier 102. A plurality of slant bars 116 are shown fixed between the center rail 110 and the top rail 108. The gaps between the slant rails 116 create a plurality of feeder openings 118 through which animals may place their heads. The barrier 102 is made from a material that is strong and weather-resistant, such as tubular galvanized steel.

The terminal ends 104 of the barrier 102 are attached to each other through an inverted-U frame member 120 that imparts some rigidity to the barrier 102 and provides a convenient location to mount accessories. A pair of wheels 122 is attached to the barrier 102 adjacent to the terminal ends 104.

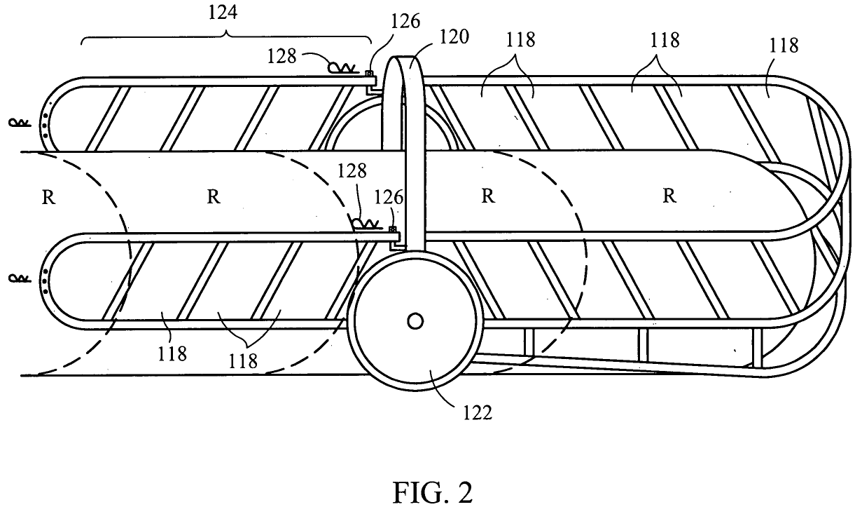

FIG. 2 shows a perspective view of a hay bale feeder 100 enveloping a plurality of round bales R arranged in a row. A removable gate assembly 124 is pivotally attached between the terminal ends 104 of the barrier 102. At least two hinge pins 126 are provided to mount each gate 124, with corresponding apertures on the gate through which the pins 126 can pass. The pins 126 are angled slightly so that the removable gates 124 will automatically open and remain approximately parallel to each other. This feature makes it easier to reposition the feeder 100 around fresh bales. The gates 124 can be locked to the feeder 100 via a removable clip 128. The free ends 130 of the gates 124 can be attached to the bales with twine to keep them from swinging free while animals are feeding. In addition, the gates 124 can be attached to another obstacle, such as an electric fence, to prevent the feeding animals from accessing the hay bales R except through the feeder openings 118. Alternatively, the obstacle, such as an electric fence, could be attached directly to the barrier 102 when the gates 124 are not needed. It should be remembered that any electric fence wire cannot be attached directly to the barrier 102 or gate 124 to prevent shocking animals while they are properly feeding. Instead, the electric fence wire is attached via an insulated material, such as an insulated handle, which will permit the electric fence to act as a barrier without interfering with feeding.

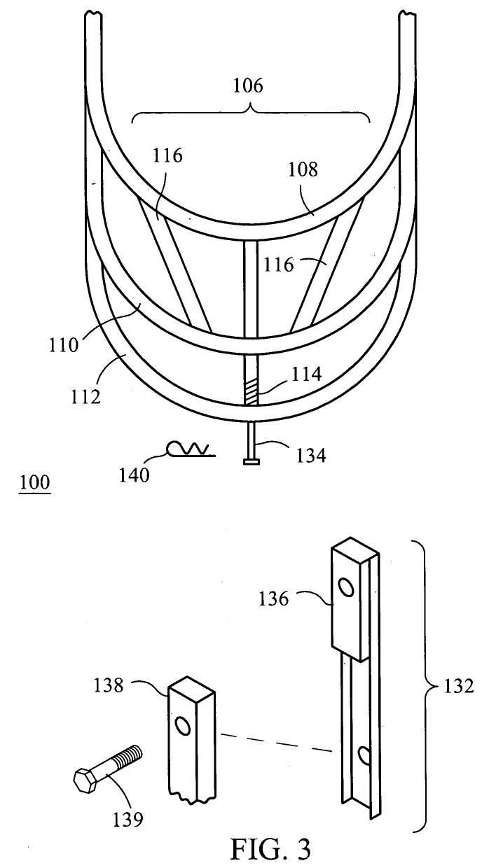

FIG. 3 shows a fragmented view of the center frame section 106 of the hay bale feeder 100 with a tractor draw bar extension 132. An anchoring stake 134 is fixed to the bottom rail 112 and allows the barrier 100 to be effectively immobilized against the forces of feeding animals. The entire barrier 100 may be picked up near the center frame section 106 by a lone individual and pushed or pulled to the desired location similar to moving a wheelbarrow. A tractor or other tow vehicle may also be employed to move the barrier 100. A drawbar extension 132 is bolted to the vehicle's draw bar 138, as shown, with the anchoring stake 134 at a second end 136. A safety pin 140 clips onto the protruding end of the anchoring stake 134 to hold the barrier to the drawbar extension 132. The drawbar extension 132 is also bolted to the towing vehicle.

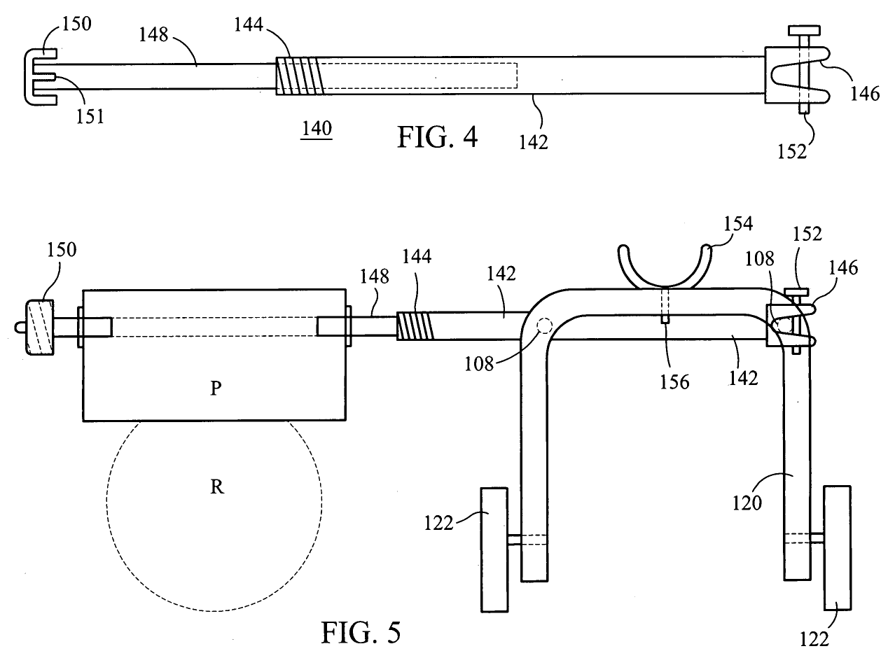

FIG. 4 is a side view of a flexible cover deployment system 140 accessory for the hay bale feeder 100. The flexible cover deployment system 140 includes a boom 142 having a threaded end 144 and a slotted end 146. The slotted end 146 preferably includes a clevis broad enough for easy attachment to the barrier 102. A bolt or heavy pin 152 traverses the opening of the clevis to close it and secure it to the barrier 102. The threaded end 144 accepts a boom extension 148 that is internally threaded at one end to bolt on end cap 150. A first end of the boom extension is inserted into the first end of the boom 144. The second end of the boom extension 148 is internally threaded to hold a threaded cap 150. This end cap 150 screws onto the threads 144 for storage about ten months of the year.

FIG. 5 is an environmental view of the hay bale feeder 100 with the flexible cover deployment system 140 extended. A roll of flexible plastic sheeting P is mounted to the boom extension 148. The slotted end 146 of the boom 142 is shown attached around the top rail 108 of the barrier 102 on the side of the barrier opposite from the roll of plastic sheeting P. The clevis fits around the top rail 108 and the bolt 152 movably attaches it to the top rail 108. The boom 142 lies over and across the top rail 108 and against the arch 120, giving it a slight upward tilt and keeping extension 148 in place and allowing some movement over rough terrain. In this position the roll of plastic sheeting P is suspended immediately above the bales of hay R and is ready to be deployed. A cradle 154 is pivotally mounted to the inverted-U frame member 120 with a pin 156 for carrying the flexible cover deployment system 140 in the stowed position.

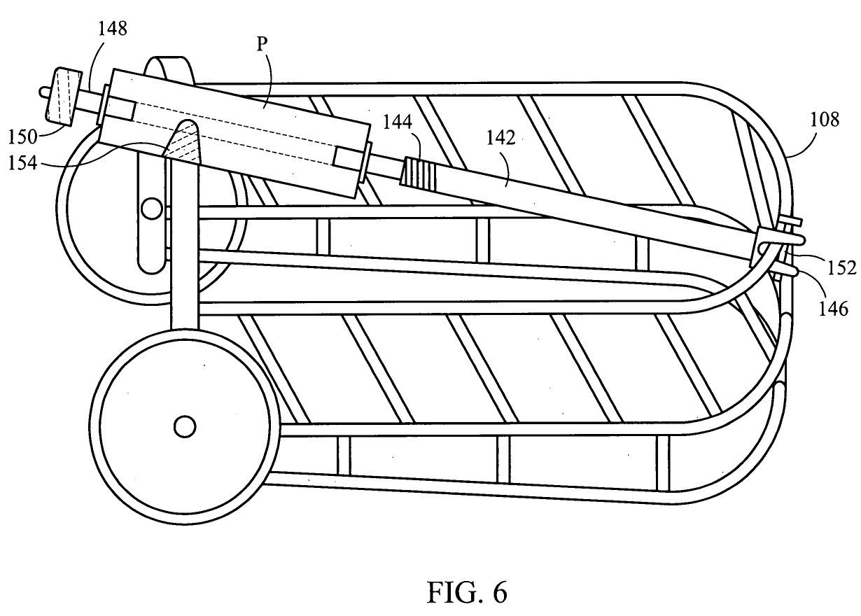

FIG. 6 is a side view of the hay bale feeder 100 with the flexible cover deployment system 140 stowed. The slotted end 146 of the boom 142 is shown attached to the top rail 108 at the center frame section 106. The boom 142, the boom extension 148 and the roll of plastic sheeting P are laid back onto the cradle 154 and ready for transport.

The boom 142 may be lashed to the feeder 100 for transport to the pasture as the feeder 100 is wheeled or towed to the far end of a row of round bales R. The boom is then released (see FIG. 5), and placed across the top rail 108 on one side while being bolted around the rail 108 on the other side, as described above. The boom 142 may extend to which ever side of the feeder 100 is most convenient.

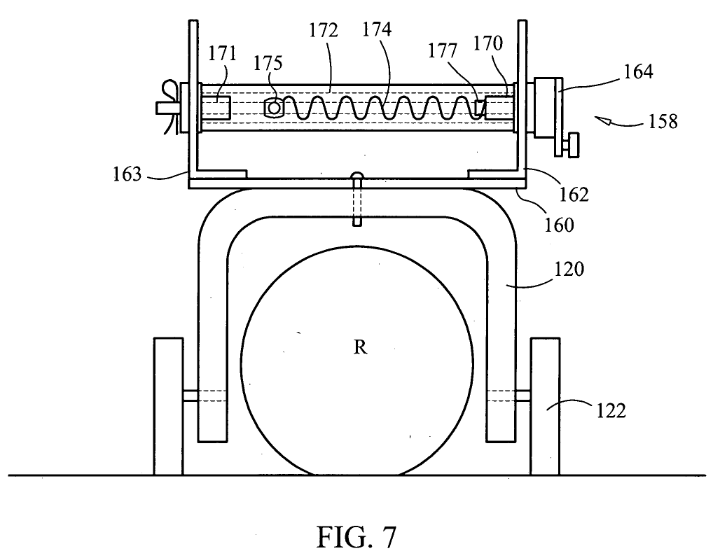

FIG. 7 is an environmental view of the hay bale feeder 100 with the flexible cover retrieval system 158 mounted. In this view, the cradle 154 of FIG. 6 has been replaced with the retrieval system 158 that is now mounted to the inverted-U frame member 120. The retrieval system 158 can be attached to the inverted-U frame member 120 in the same manner as the cradle 154 shown in FIG. 5.

The flexible cover retrieval system 158 includes a base plate 160 with a pair of carrier brackets 162, 163 attached at opposite ends of the base plate 160. A hand crank assembly 164 is attached outboard of one carrier bracket 162. The hand crank assembly 164 includes a crank handle and an internally-toothed ring gear that is rotatably-mounted to bracket 162. A drive gear is inside the ring gear and is also mounted to bracket 162. The drive gear engages the ring gear and turns about three turns for each turn of the crank handle and ring gear. A pawl is inside the ring gear and selectively engages the teeth of the ring gear depending on the position of a ratchet selector.

A center shaft 168 is attached through bracket 162 to the drive gear. The center shaft 168 extends across the width of the retrieval system 158 and through bracket 163. An adapter hub 170 is rotatably mounted onto the center shaft 168 at carrier bracket 162 to adjust the center shaft 168 to the interior diameter of the spool 172 onto which the plastic sheeting P is rolled. A second adapter hub 171 is rotatably mounted on center-shaft 168 at carrier bracket 163.

An internal spring 174 is brazed to a brass ring 175 at one end and is secured to shaft 168 near bracket 163 with an allen-head set screw. A dimple on the shaft 168 ensures proper placement of the ring and set screw on the shaft 168.

The opposite end of the spring 174 also has a brass clearance ring 177 with a small hole on one side to position and braze-the spring 174. The opposite side of the ring 177 is attached to the hub 170 with another set screw. The ring 177 also has a spur on its major diameter that engages the spool 172. The spool 172 can be a length of tubing, such as thin-wall PVC, via a keyway or slot. This tubing is the core for the subsequent roll of plastic sheeting P. The bracket 163 must be removed to install and remove the spool 172.

The pawl selectively prevents the spool 172 from turning in one direction. In this manner winding energy can be stored in the spring 174 to assist in retrieving the plastic sheet P.

### Operation

To recover deployed plastic sheet P the user will place the retrieval system 158 immediately adjacent to the deployed plastic sheeting P. The user will lay the end of the sheet P along the spool 172 and fix the plastic sheet P in place with a removable adhesive, such as duct tape. The ratchet selector is then engaged and the crank handle is turned to wind the spring 174. When the ratchet selector is disengaged, the spring 174 will bias the spool 172 in a rotational manner to wind the plastic sheet P onto the spool 172.

An optional roof assembly (not shown) can be attached to brackets 162 and 163 to protect the retrieval system 158 from snow and ice. The various hay balers available today produce bales of 4, 5 or 6-foot widths. The retrieval system 158 would work well with all those sizes with only minimal adjustments.

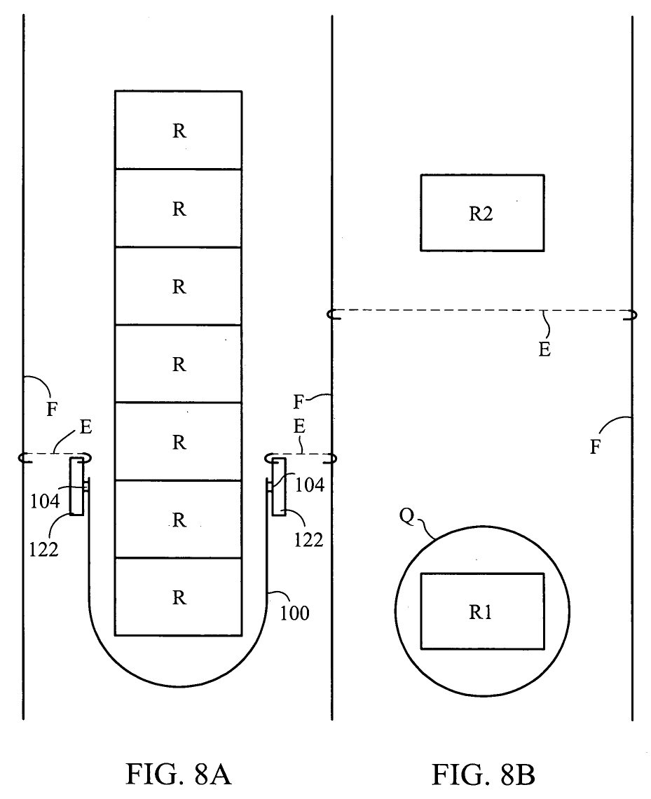

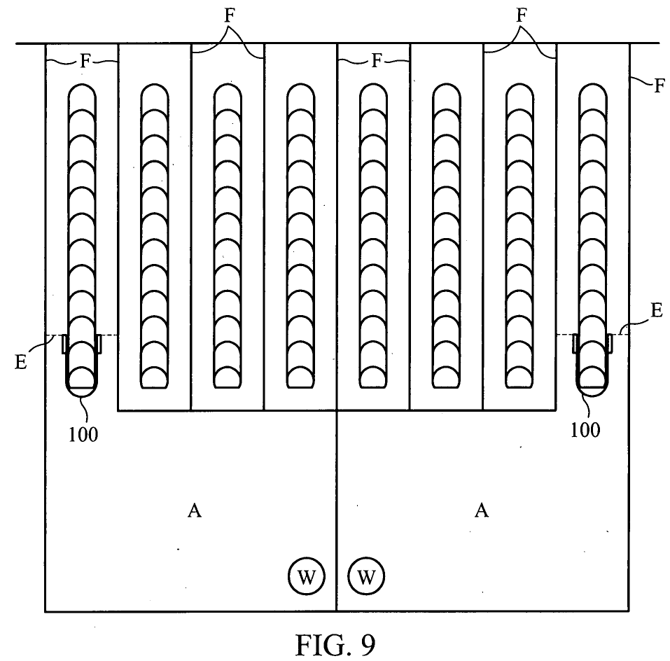

FIG. 8A shows an elevated environmental view of the feeder assembly 100 in use, while FIG. 8B shows a typical prior art feeder assembly system. FIG. 8A shows how a long row comprising dozens of bales R can be assembled with no space between them. The feeder 100 is located at one end of the row of bales R. A fence F is shown surrounding the bales R on three sides. An electric fence, or other temporary barrier is erected between the feeder 100, near its terminal ends 104, and the Fence F. This forces the animals to feed through the feeder 100 and keeps most of the bales R out of reach and in a reserve status.

FIG. 8B shows the prior art feeder system Q, which uses the same types of bales R, but with a round bale feeder Q than completely surrounds a single bale R1. Bales R2 on reserve are kept apart, individually, behind a barrier, such as an electric fence F. A minimum of 15-17 feet is required between each of the bales R1, R2. As the animals consume a bale R1, the feeder Q must be relocated to a new bale R2, or the new bale R2 must be relocated to the feeder Q. Bales R can weigh 1000 pounds, and cannot be moved by hand. The feeder Q has no wheels and must be tilted onto its side and rolled to the new bale R2. This is also hazardous due to the size and weight of the feeder Q.

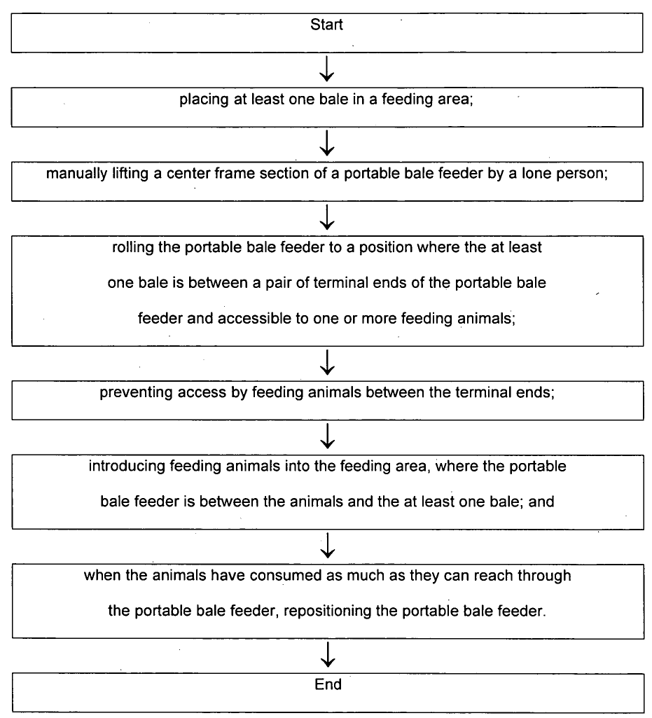

FIG. 9 shows an elevational environmental view of the feeder system in use. A plurality of rows of bales R are arranged in a field with no spacing between individual bales R in a single row. Each row is separated by a fence F and each feeder 100 has a barrier E between it and the closest fence F. The feeder system 100 controls animal access to the bales R. It prevents the animals from trampling and sullying the feed, and controls aggressive behavior that might otherwise result from jostling for feed. Water W may be located some distance away.

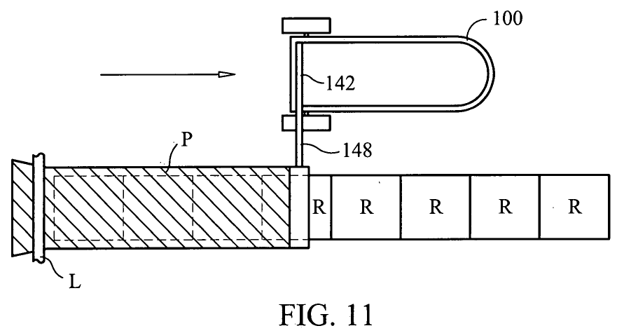

FIG. 10 is a flowchart of the steps in a feeder system. The method of using the portable bale feeder 100 starts, step 200, by placing at least one bale in a feeding area A, step 202. As shown in FIG. 9, numerous rows of bales R can be placed in a relatively small feeding area A. Next, step 204, the lone user manually lifts the center section 106 of the portable bale feeder 100, and rolls the portable bale feeder 100 to a position where the bale or bales R are between the pair of terminal ends 104 of the portable bale feeder 100 and are accessible to one or more feeding animals, step 206. The center section 106 of the portable bale feeder 100 is lowered to the ground and secured with an anchoring stake 134 to prevent movement of the portable bale feeder 100 by the feeding animals. The lone user then prevents access by feeding animals between the terminal ends 104 of the feeder 100, step 208. This can be accomplished by erecting one or more electric barriers E between the terminal ends 104 and the bale R.

Next, step 210, the user introduces feeding animals into the feeder area A. The portable bale feeder 100 is between the animals and the bale or bales R. Finally, step 212, when the animals have consumed as much as they can reach through the portable bale feeder 100, a lone user easily repositions the portable bale feeder 100, ending the process at step 214. The user rolls the portable bale feeder 100 down the row of bales R so that at least one bale is between the pair of terminal ends 104 of the portable bale feeder 100 and is accessible to feeding animals.

As shown in FIG. 9, a single row of bales R is consumed before starting the next row. The last row of bales can be in the field for a long time, so proper protection is necessary to prevent spoilage and deterioration.

FIG. 11 is an elevational environmental view of the flexible cover deployment system 140 in use. The cover deployment system 140 provides protection for the bales R until they are needed. Plastic sheet material is furnished in rolls for conventional baling and wrapping machines, which are usually designed to wrap each hay bale individually about its entire circumference. The feeder 100 is shown equipped with the cover deployment system 140 for extending a single plastic cover P over an entire row of hay bales R. This plastic covering P is provided wound on a cardboard spool 172 of various inside diameters. Thus, two plastic adapter hubs 170, 171 are supplied to fit between the spool 172 and the spool support shaft 168. These are tightly pressed into the spool 172 to provide a good bearing surface as the plastic covering is unwound.

Two pieces of twine, such as sisal twine, are cut on each bale R near ground level, and the free end of the twine is thrown over the bale R to the opposite side. This process is continued for a whole row.

A length of plastic cover P is unrolled adjacent to the first bale R in the row to be covered. The plastic cover P should reach at least to the ground, plus an additional few feet. The unrolled end of the plastic cover P is anchored by placing a fence post L, or other suitable ballast, on the ground across the top of the cover P. The twine ends are tied together to secure the plastic cover P over the top of each bale R. The feeder 10 may then be Wheeled or drawn adjacent to the row, as shown in FIG. 4 periodically securing the cut twine T to each bale R. When the entire row of bales R has been covered and tied, the plastic cover P is cut and secured. Finally, the boom 142 can be removed from the top rail 108, and lashed to the feeder 100. Then the boom 142 and any plastic cover P remaining on the spool 172 are wheeled back to the barn for storage.

The bale feeder 100 may also be equipped with a cover retrieval system 158 so that the plastic cover P may be reused. The retrieval apparatus is shown in FIG. 7.

The spool support shaft 168 winds, and is subsequently driven by, a coil spring 174 which is fixed to hub 170 at one end and spool support shaft 168 at the other end. Adapter hubs 170 and 171 are not connected directly onto the shaft 168, but are free to rotate about it.

Shaft 168 has a bolt, such as an allen head bolt, penetrating its face and extending somewhat across the outer surface of the shaft 168 to act as a key to prevent slippage of the roll of plastic P which has a matching engagement slot across one end of its core. Shaft 168 has the coil spring 174 permanently attached inside. The other end of spring 174 is fixed to a brass ring with a hole drilled and tapped for a set screw to affix it to shaft 168. An empty plastic roll core 172 is pressed onto the hubs 170 and 171, and an end of the cover P is wrapped onto the core 172. The coil spring 174 is wound using the hand crank 164 and ratchet 166 until the spring 174 is taut, and the feeder 100 is pushed along the row of hay bales R with the arch 120 positioned over the bale R. The feeder 100 takes up the cover P onto the core 172, under spring power, as the feeder 100 is advanced along the row of bales R.

I claim:

1. A portable bale feeder comprising:
a semicircular barrier having a pair of terminal ends and a center frame section;
an inverted U frame member attached to the terminal ends of the semicircular barrier;
a pair of wheels attached adjacent to the terminal ends; and
an anchoring stake.

2. The portable barrier feeder of claim 1, where the barrier further comprises
a plurality of semicircular horizontal bars; and
a plurality of cross links attached and perpendicular to the horizontal bars.

3. The portable barrier feeder of claim 2, further comprising
a plurality of slant bars attached between two or more of the semicircular horizontal bars to create a plurality of feeder openings.

4. The portable barrier feeder of claim 1, further comprising
a removable gate assembly pivotally attached between the terminal ends of the semicircular barrier.

5. The portable barrier feeder of claim 1, where the removable gate assembly comprises
a plurality of horizontal bars; and
a plurality of slant bars attached between the horizontal bars to create a plurality of feeder openings.

6. The portable barrier feeder of claim 1, further comprising
a flexible cover deployment and retrieval system.

7. The portable barrier feeder of claim 6, where the flexible cover deployment and retrieval system comprises a boom, having an inboard end and an outboard end, that is removably attached at the inboard end to the semicircular barrier adjacent to one of the terminal ends.

8. The portable barrier feeder of claim 7, where the boom comprises
a threaded outboard end;
and a threaded cap that is threadedly attached to the outboard end of the boom.

9. The portable barrier feeder of claim 1, further comprising a
flexible cover reel mechanism pivotally attached to the inverted U frame member

10. The portable barrier feeder of claim 9, the flexible cover reel mechanism further comprising:
a base plate pivotally attached to the inverted U frame member;
a pair of carrier brackets, one carrier bracket at each end of the base plate;
a spool support shaft rotatably inserted through the carrier brackets;
a hand crank assembly attached to a-first carrier bracket;and a first end of the spool support shaft;
a ratchet attached to hand crank assembly;
a pair of spool adapter hubs, the hubs being concentric with the spool support shaft and both hubs being inboard and adjacent to the carrier brackets; and
a coil torsion spring fixed at a first end inside the spool support shaft and fixed at a second end outside the spool support shaft.

11. A method of using a portable bale feeder, comprising the steps of:
(a) placing at least one bale in a feeding area;
(b) manually lifting a center frame section of a portable bale feeder by a lone person;
(c) rolling the portable bale feeder to a position where the at least one bale is between a pair of terminal ends of the portable bale feeder and accessible to one or more feeding animals;
(d) preventing access by feeding animals between the terminal ends;
(e) introducing feeding animals into the feeding area, where the portable bale feeder is between the animals and the at least one bale; and
(f) when the animals have consumed as much as they can reach through the portable bale feeder, repositioning the portable bale feeder.

12. The method of using a portable bale feeder of claim 11, where step (a) further comprises the step of:
(a1) placing one or more rows of round bales in the feeding area.

13. The method of using a portable bale feeder of claim 11, where step (c) further comprises the steps of:
(c1) lowering the center frame section of the portable bale feeder to the ground; and
(c2) securing an anchoring stake to prevent movement of the portable bale feeder.

14. The method of using a portable bale feeder of claim 11, where step (d) further comprises the step of:
(d1) erecting one or more electric barriers between the terminal ends and the at least one bale.

15. The method of using a portable bale feeder of claim 11, where step (f further comprises the step of:
(f1) rolling the portable bale feeder so that at least one bale is between the pair of terminal ends of the portable bale feeder and accessible to feeding animals.
